(19) United States
(12) Patent Application Publication
(10) Pub. No.: US 2009/0302495 A1
(43) Pub. Date: Dec. 10, 2009

(54) SOLUTION CASTING METHOD AND SOLUTION CASTING APPARATUS FOR FILM MANUFACTURE

(75) Inventors: Nobuo Hamamoto, Kanagawa (JP); Taro Shimokouchi, Kanagawa (JP); Yuji Suzuki, Kanagawa (JP)

Correspondence Address: YOUNG & THOMPSON, 209 Madison Street, Suite 500, ALEXANDRIA, VA, 22314, US

(73) Assignee: FUJIFILM CORPORATION, MINATO-KU (JP)

(21) Appl. No.: 12/282,967

(22) PCT Filed: Mar. 13, 2007
(86) PCT No.: PCT/JP2007/055581

§ 371 Date: Mar. 16, 2009

(30) Foreign Application Priority Data
Mar. 15, 2006 (JP) 2006-071455

(51) Int. Cl. B29D 7/01; B29D 7/00

(52) U.S. Cl. 264/216; 425/224

(57) ABSTRACT

A dope (21) is cast from a casting die (30) onto a casting drum (32) that is moving. The dope forms a bead (21a) between the casting die and the casting drum. Provided downstream from the bead in a casting drum's moving direction is nozzles (61a, 61b) which supply a solidification preventive solution around side ends (22b) of a downstream surface of the bead. On an upstream side of the bead, air pressure is reduced by a decompression chamber (36). Since the bead separates airflow of the upstream side from the downstream side, the solidification preventive solution is not blown in the airflow from the upstream side.

### TECHNICAL FIELD

The present invention relates to a solution casting method and a solution casting apparatus for manufacturing films.

### BACKGROUND ART

Polymer films (hereinafter, films) are widely used as an optical function film because of their excellent light transmission property, excellent flexibility, and ability to be lightened and thinned. Among these, the films of cellulose esters, such as cellulose acylate, are durable and hardly cause double refraction, and are therefore used for various kinds of films ranging from photosensitive films to a protection film in a polarizing filter and an optical compensation film for liquid crystal display devices (hereinafter, LCD).

Generally, the manufacturing methods of these films can be divided into two types, a melt extrusion method and a solution casting method. The melt extrusion method is that a polymer is heated to molten state and pulled out through an extrusion device. While showing good productivity with relatively low equipment cost, the melt extrusion method is not suitable for the optical function film and such high quality films because the film thickness is not controlled very precisely, and thin lines (so called, die lines) are sometimes formed on the film in this method. To the contrary, the solution casting method yields the films with better optical isotropy, better thickness uniformity, and fewer foreign substances than the melt extrusion method. Accordingly, the optical function films are usually manufactured by the solution casting method.

In the solution casting method, a dope material is firstly prepared by dissolving cellulose acetate or such polymer in a mixed solvent composed primarily of dichloromethane or methyl acetate. Some additives are mixed with the dope material to prepare a casting dope. The casting dope is fed to a casting die and released from a discharge slit thereof to a casting drum, an endless band, or such a continuously moving support (hereinafter, a casting process). The released dope forms a bead between the discharge slit and the support, and becomes a casting film on the support. The casting film is transported at a constant speed by the support, and cooled or dried to have self-supporting property. This casting film is peeled from the support and becomes a wet film, which is then dried (hereinafter, drying process) and wound as a film product. In the casting process, a solidification preventive solution is supplied on both side end areas of the casting dope. This solution prevents the casting dope from solidifying around the side edges of the discharge slit in the casting die. Introduced additionally in the casting process is a decompression chamber which reduces the air pressure to a predetermined value on an upstream side of the dope in the support's moving direction (hereinafter, back side), so that the bead will come in close contact with the support. Accordingly, air bubbles and such undesired matters hardly enter between the casting film and the support.

In recent years, thin display devices such as LCD and organic EL displays are fast becoming popular, and high speed solution casting is demanded in the film manufacturing process accordingly. In view of this demand, Japanese Patent Laid-open Publication No. 2005-104148 discloses a solution casting method in which a liquid mixture of good and poor solvents for the bead's polymer is used as the solidification preventive solution. Adjusted to contain a lesser amount of the poor solvent than the good solvent, this solution renders the bead to have flexible side edges. Thereby, the bead is kept stabilized against the suction of the decompression chamber, and the high speed solution casting is achieved.

It is well known that the duration of the solution casting method depends on the speed of the casting process. Obviously, if the supporting member moves faster, the speed of the casting process can be improved. However, the close contact of the casting film and the support is not achieved when the support moves at high speed (at 80 m/min and faster). To achieve the close contact, the air pressure has to be more reduced on the back side of the bead. Unfortunately, when the air pressure is reduced by 100 Pa or more, the solidification preventive solution is blown by this strongly reduced air pressure. Some of the blown solutions bounce off such components as a wind shielding plate in the decompression chamber, the side walls of the chamber, and the supporting member, and reach the productive part of the bead. The solidification preventive solution in the bead deforms the casting film's surface, and may even cause surface defect to the film product.

It is therefore an object of the present invention to provide a solution casting method which enables a high speed solution casting process without causing surface defect to the film.

### DISCLOSURE OF INVENTION

In order to achieve the above and other objects, a solution casting method according to the present invention includes a casting step, a decompression step, and solution supply step. In the casting step, a dope of a polymer and a solvent is cast from a casting die onto a moving support. Along the way, the dope forms a bead between the die and the support. In the decompression step, air pressure is reduced on an upstream side of the bead in the support's moving direction. In the solution supply step, a solidification preventive solution is supplied to both side end portions of a downstream surface of the bead in the support's moving direction. The solidification preventive solution prevents the dope from solidifying on the die.

It is preferred that the support moves at or above 80 m/min, and that the air pressure on the upstream side is reduced by 100 Pa or more with respect to a downstream side of the bead.

In a preferred embodiment of the present invention, the support is a peripheral surface of a casting drum, and the solvent and the solidification preventive solution include a good solvent for the polymer as their main components. It is further preferred that the polymer contains cellulose acylate or cyclic polyolefin, and that the good solvent is dichloromethane or methyl acetate.

A solution casting apparatus according to the present invention includes the moving support, the casting die, a decompression chamber, and a solution supply device. The decompression chamber reduces air pressure on the upstream side of the bead. The solution supply device supplies the solidification preventive solution from a wall surface of the casting die to both side end portions of a downstream surface of the bead.

It is preferred that the support moves at or above 80 m/min, and that the decompression chamber reduces the air pressure on the upstream side by 100 Pa or more with respect to a downstream side of the bead.

In a preferred embodiment of the present invention, the support is a peripheral surface of a casting drum, and the solvent and the solidification preventive solution include a good solvent for the polymer as their main components. It is further preferred that the polymer contains cellulose acylate or cyclic polyolefin, and that the good solvent is dichloromethane or methyl acetate.

Additionally, the solution supply device includes a pair of nozzles whose openings are located at both side end areas of the wall surface of the casting die. It is preferred in this case that each of the openings is placed with clearances CL1 and CL2 in the range of 1-5 mm. The clearance CL1 is the space between the nozzle tip and the bead surface, and the clearance CL2 is the space between an extension of a center line of the nozzle and the bead side edge.

According to the present invention, the bead separates the airflow between the upstream side and the downstream side, and the solidification preventive solution is hardly blown in the air flow toward the decompression chamber. Accordingly, the films are manufactured effectively by the solution casting method. The effect of the present invention will be particularly apparent in a high speed solution casting process, where the support moves at or above 80 m/min and the air pressure is reduced by 100 Pa or more.

### BRIEF DESCRIPTION OF DRAWINGS

FIG. 1 a block diagram of a film manufacturing apparatus according to the present invention;

FIG. 2 is a lateral view around a discharge slit of a casting die;

FIG. 3 is a perspective view illustrating a structure of a decompression chamber; and

FIG. 4 is a front view around the discharge slit of the casting die, viewed from a downstream side of the casting drums moving direction.

### BEST MODE FOR CARRYING OUT THE INVENTION

### Solution Casting Method

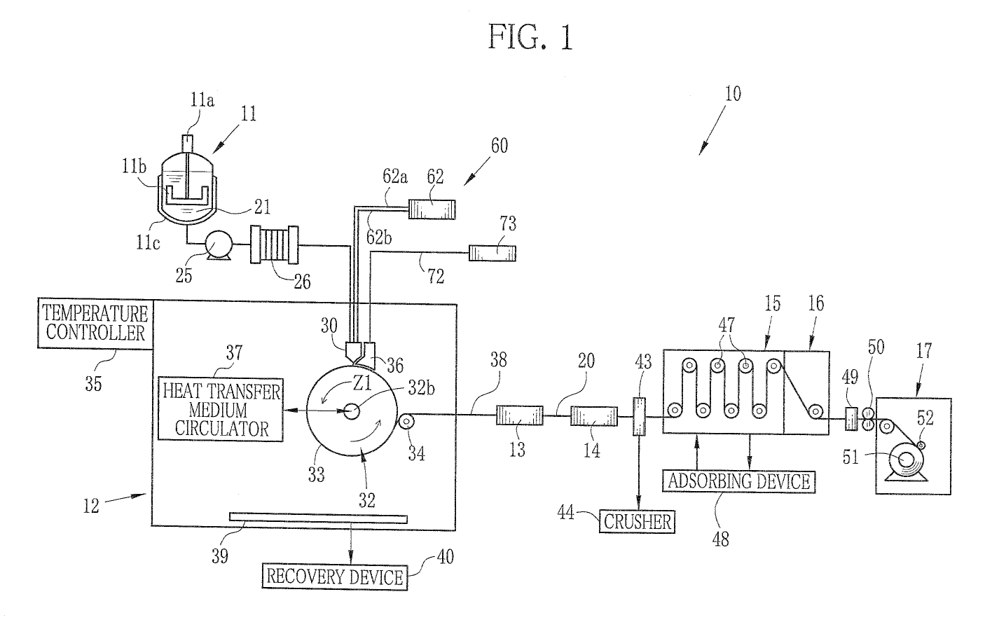

Referring to FIG. 1, a film manufacturing apparatus 10 includes a stock tank 11, a casting chamber 12, a pin tenter 13, a clip tenter 14, a drying chamber 15, a cooling chamber 16, and a winding chamber 17.

The stock tank 11 is a container for a dope 21, i.e., the material of a film 20, and equipped with a stirring blade 11b and a jacket 11c. The jacket 11c is attached to the exterior surface of the stock tank 11, and keeps the dope 21 at an approximately constant temperature. The stirring blade 11b stirs the dope 21 to prevent the aggregation of the polymer in the dope 21. The stock tank 11 is connected to a pump 25 and a filtering device 26.

The casting chamber includes a casting die (hereinafter, die) 30 to cast the dope 21, a casting drum (hereinafter, drum) 32 as a support, a peel roller placed near a peripheral surface 32a of the drum 32 to peel a casting film 33 from the drum 32, and a temperature controller 35 to adjust an internal temperature of the casting chamber 12. Additionally, a decompression chamber 35 is provided near the peripheral surface 32a between the die 30 and the peel roller 34.

Provided at a tip of the die 30 is a discharge slit 30a from which the dope 21 is discharged. The dope 21 is cast from the discharge slit 30a onto the peripheral surface 32 of the drum 32 that lies below the discharge slit 30a.

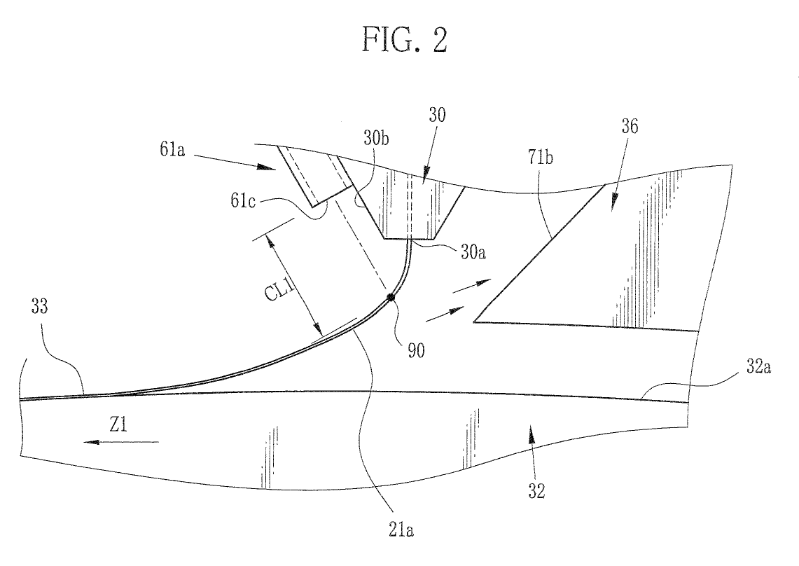

The material for the die 30 is preferably a precipitation hardening stainless steel with the coefficient of thermal expansion of 2×10⁻⁵(° C.⁻¹) or less. Alternatively, the die 30 can be made from a material to show substantially the same resistance to corrosion as a SUS316-made die in the corrosion test using an electrolyte solution, and/or a material having the resistance to corrosion enough to withstand for 3 months in a mixed liquid of dichloromethane, ethanol, and water without pitting at air-liquid interface. Preferably, these materials should be left for 1 months or more after the foundry, and then ground into the die 30. Allowing the dope 21 to flow uniformly, the die 30 made in this way prevents the formation of lines or other defects in casting film. Additionally, it is preferred that the die 30 is precisely finished to a surface roughness of 1 μm or less and a straightness of 1 μm/m or less in all directions. On the die 30, the clearance of the discharge slit 30a (see, FIG. 2) is changed automatically in the rage of 0.5 mm to 3.5 mm. The die 30 has a tip (lip tip) rounded into or below 50 μm radius on the solution flowing side. It is also preferred that the shear velocity of the dope 21 inside the die 30 was in the range of 1(1/sec) to 5000(1/sec). Using this die 30 allows to form a smooth and even casting film 33 on the peripheral surface 32a of the drum 32.

The die 30 is not limited in width particularly, but should preferably be 1.1-2.0 times as wide as the final film product. Also preferably, the die 30 is equipped with a temperature controller (not shown), and kept at a predetermined temperature during the casting process. A coat hanger die is suitable for the die 30. Additionally, thickness adjustment bolts (heat bolts) should preferably be aligned at certain intervals along the width of the die 30, so that the die 30 will offer an automatic thickness adjustment function. In this case, the heat bolts create and work on a profile according to the flow rate of the pump (for example, a high-precision gear pump) 25. Additionally, the heat bolts may also work under the feed back control of an adjustment program moving on the profile of a thickness gauge (for example, an infrared thickness gauge) that is provided in the film manufacturing apparatus 10. The die 30 should be adjusted to provide the film product with 1 μm or less thickness difference in the width direction after removal of the film's side edges, and with 3 μm or less thickness variation, preferably 2 μm or less thickness variation, along the width direction. Is preferred that the die 30 can adjust the film thickness in the range of ±1.5 μm or more precisely.

The lip tip of the die 30 should preferably be coated with a hardened layer. The hardened layer may be formed by ceramic coating, hard chrome plating, or nitriding treatment. A ceramic, if used for the hardened layer, should be grindable, low in porosity, unbreakable, good in resistance to corrosion, good in adhesion to the die 30, and poor in adhesion to the dope 21. Such a ceramic may be tungsten carbide (WC), Al₂O₃, TiN, Cr₂O₃, and particularly preferable among these is WC. The WC hardened layer can be formed by a spraying technique.

The drum 32 has a substantially cylindrical or columnar shape, and is rotated around its axis 32b by a drive unit (not shown). The peripheral surface 32a of the drum 32 therefore rotates at a desired constant speed (10-300 m/min) in a moving direction Z1. Plated with chrome, the peripheral surface 32a has sufficient resistance to corrosion and sufficient strength. Additionally, the drum 32 is connected to a heat transfer medium circulator 37 to keep the peripheral surface 32a at a certain temperature. The heat transfer medium at controlled temperature flows from heat transfer medium circulator 37 to a passage inside the drum 32, and the peripheral surface 32a is kept at a desired temperature.

As shown in FIG. 2, the dope 21 in the casting process is released from the die 30 onto the peripheral surface 32a of the drum 32. The released dope 21 creates a bead 21a between the die 30 and drum 32, and then forms a casting film 33 on the peripheral surface 32a. This casting film 33 is transported at a constant speed by the drum 32 that rotates in the moving direction Z1. On a back side of the bead 21a, the air pressure is reduced by the decompression chamber 36 for the purpose to stabilize the bead 21a. The decompression chamber 36 can reduce the air pressure by the range of 2000 Pa to 10 Pa. Cooled to develop a self-supporting property on the drum 32, the casting film 33 is peeled from the drum 32 by the peel roller 34, as shown in FIG. 1, and becomes a wet film 38.

The temperature controller 35 keeps an approximately constant temperature in the casting chamber 12. The internal temperature of the casting chamber 12 may preferably be the range of 10-30° C. Provided further in the casting chamber 12 are a condenser 39 to condense and collect organic solvent vapor and a recovery device 40 to recover the solvent liquid from the condenser 39. The recovered solvent is restored by a restoring device (not shown) and used again as a dope solvent. The recovery device 40 should preferably adjust the solvent saturation temperature in the casting chamber 12 to the range of −10° C. to 10° C.

The casting chamber 12 is connected to a pin tenter 13 for drying and a clip tenter 14. The pin tenter 13 is a drying device with plural pins to hold the film, and converts the wet film 38 into a dried film 20. The clip tenter 14 is also a drying device equipped with plural clips to hold the film. Dried and stretched in the clip tenter 14 under a predetermined condition, the film 20 develops a desired optical property. It is to be noted that the clip tenter 14 is optional.

The clip tenter 14 is connected to an edge slitting device 43 to cut off the side edges of the film 20. The edge slitting device 43 is connected to a crusher 44 which breaks the side edges into small fragments. These fragments are reused as a material dope.

The drying chamber 15 has a plurality of rollers 47 and an adsorbing device 48. Additionally, the drying chamber 15 is attached to the cooling chamber 16, which is then connected to a neutralization device (neutralization bar) 49. On the downstream of the neutralization device 49, a knurling roller 50 is provided. The winding chamber 17 houses a winding shaft 51 and a press roller 52.

As shown in FIG. 1 and FIG. 2, a solution supply device 60 is composed of nozzles 61a, 61b, a tank 62, and pipes 62a, 62b. The nozzles 61a, 61b are both attached to a front side surface of the die 30. Here, the front side means the downstream side in the moving direction Z1 of the drum 32, and the nozzles 61a, 61b are located at each side end portions of the surface. The tank 62 holds a solidification preventive solution (hereinafter, preventive solution) that prevents the solidification of the dope 21, and is equipped with a temperature controller (not shown) to keep the preventive solution at a predetermined temperature. The pipes 62a, 62b connect the tank 62 with nozzles 61a, 61b respectively. Each of the pipes 62a, 62b is equipped with a bulb, a pump, and a f low meter (all not shown), and able to send a desired amount of the preventive solution at a desired flow rate from the tank 62 to the nozzles 61a, 61b.

It is preferable to supply the preventive solution around a contact area of a side end 21b of the bead 21a, the lip tip of the die 30, and ambient air. The amount of the preventive solution should preferably be not less than 0.1 ml/min and not greater than 11.0 ml/min on each side end of the bead 21 in order to prevent the foreign matters being mixed into the casting film 33. The pump for the nozzles 61a, 61b should preferably have a pulse rate of 5% or less.

Each of the nozzles 61a, 61b has a supply port 61c (see, FIG. 2) at the tip. The supply port 61c contacts the front side wall surface 30b of the die 30, and the preventive solution from the tank 62 goes out of the supply port 61c to flow down the wall surface 30b, and then reaches the side end areas of the bead 21a below the discharge slit 30a. The supply port 61c is substantially circular, so that the preventive solution can flow into the wall surface 30b easily. It is to be noted that FIG. 1 only shows the nozzle 61a, and that the nozzle 61b is also provided on the other end of the wall surface 30b.

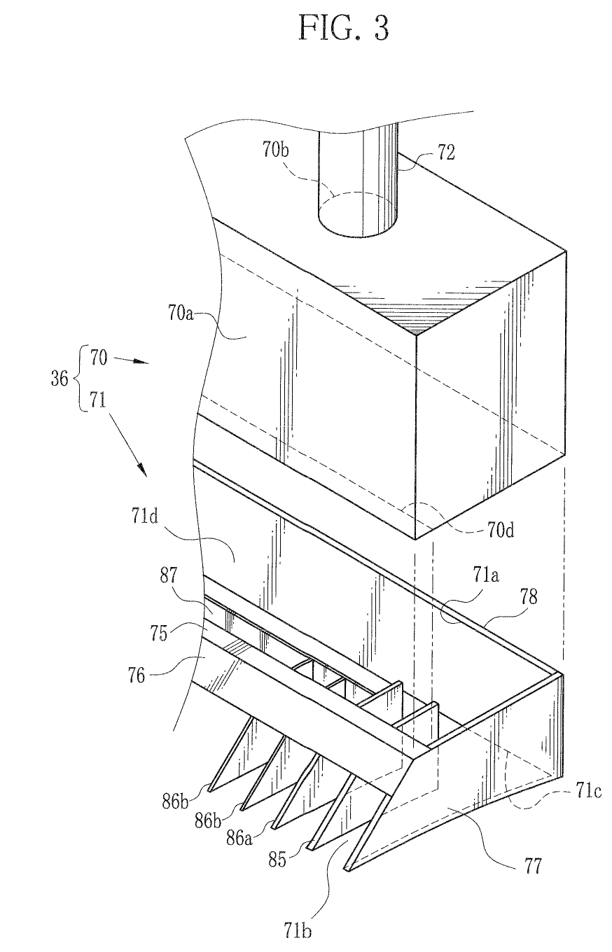

As shown in FIG. 3, the decompression chamber 36 is composed of an upper section 70 and a lower section 71. The upper section 70 has a rectangular parallelepiped shape with a cavity 71a inside, and its upper surface has a connection hole 70b to the cavity 71a. This cavity 70a has an opening 70d at the bottom. Inserted to the connection hole 70b is a pipe 72 which is connected a suction device 73 (see, FIG. 1).

The lower section 71 has a box shape, with a cavity 71a inside, defined by an upper seal plate 75, a front seal plate 76, a pair of side seal plates 77, and a rear seal plate 78. Also, the lower section 71 has openings 71a, 71b, and 71c respectively at the top, the front, and the bottom thereof. The clearance between the front seal plate 76 and the die 30 is filled by a packing (not shown).

Inside the cavity 71d, a plurality of partition plates 85, 86a, 86b are arranged from the lateral side toward the center and parallel to the side seal plate 77. The partition plates 85, 86a, 86b are fixed to the upper seal plate 75 and the front seal plate 76. Additionally, the partition plates 86a and 86b are fixed at the rear end to a support plate that keeps the intervals between these plates 86a and 86b. The partition plates 85, 86a, 86b create airflow substantially opposite to the moving direction Z1 of the peripheral surface 32a at side end areas in the cavity 71d. It is preferred that the number of the partition plates 86b may be changed according to the width of the bead 21a to create the airflow substantially opposite to the moving direction Z1 in the cavity 71d.

The upper section 70 and the lower section 71 are joined together to make the openings 70d and 71a airtight, and the decompression chamber 36 is formed. The decompression chamber 36 is arranged to bring the packing into contact with the die 30, and thus the opening 71b and the cavities 71d, 70a create an airtight, low pressure zone.

When the suction device 73 is activated, the air pressure in the cavities 70a, 71d is reduced to a predetermined value. Along with this, the air pressure around the opening 71b is also reduced to the predetermined value. Accordingly, as shown in FIG. 2, the air pressure on the back side, i.e., the upstream side in the moving direction Z1, of the bead 21a is reduced to the predetermined value.

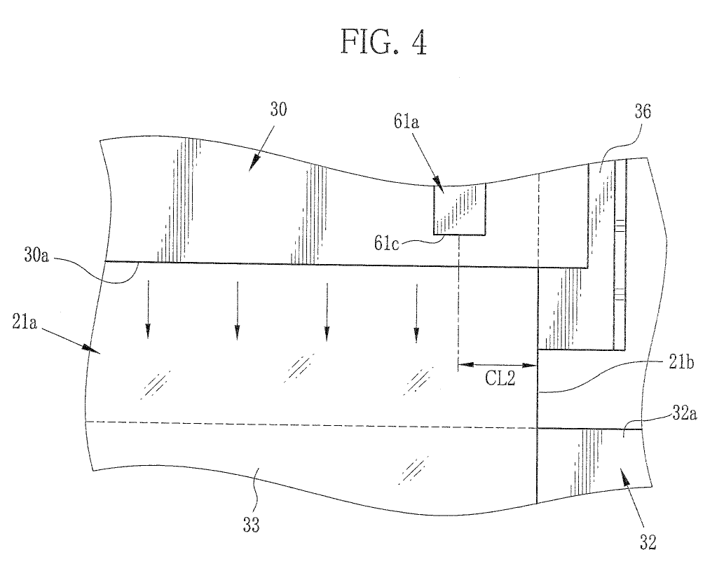

As shown in FIG. 2 and FIG. 4, each of the nozzles 61a, 61b is placed with clearances CL1 and CL2. The clearance CL1 is a space between the center of the supply port 61c and a midpoint 90 on the bead 21a. Particularly, the midpoint 90 is on or around the intersection of a center line of the supply port 61c and the bead's surface. The clearance CL2 is a space between an extension of a center line of the supply port 61c and the side end 21b of the bead 21a.

Next, the operation of the film manufacturing apparatus 10 is explained with reference to FIG. 1. The dope 21 in the stock tank 11 is kept at a constant temperature of 25-35° C. by the heat transfer medium flowing inside the jacket 11c, and homogenized by the rotation of the stirring blade 11b. The dope 21 is transferred by the pump 25 to the filtering device 26 which removes impurities from the dope 21.

The drum 32 is rotated in the moving direction Z1 at a constant speed (the range of 80-300 m/min) by the drive unit. The peripheral surface 32a of the drum 32 is kept at an approximately constant temperature in the range of −10° C. to 10° C. by the heat transfer medium circulator 37. The dope 21 at in the range of 30-35° C. is cast on the peripheral surface 32a, on which the dope 21 forms the casting film 33. The casting film 33 on the drum 32 turns into a solid (gel) and develops a self-supporting property. As it is cooled, the casting film 33 generates bridges that grow into a crystal base, and the gelation proceeds. The casting film 33 with the self-supporting property is then peeled from the drum 32 by the peel roller 32, and becomes the wet film 38. The wet film 38 is sent by the peel roller 32 to the pin tenter 13.

In the pin tenter 13, the wet film 38 is held by the pins along the side edges, and dried to be the film 20 as it is transported. The film 20, still containing the solvents at this stage, is sent to the clip tenter 14.

The clip tenter 14 holds the side edges of the film 20 between the clips that can move continuously with an endless chain. While transporting and drying the film 20, the clip tenter 14 stretches the film 20 in the width direction. This stretching process orients the molecules of the film 20, and gives a desired retardation to the film 20, or adjusts the retardation of the film 20.

Out of the clip tenter 14, the film 20 reaches the edge slitting device 43 and the side edges thereof are cut off. The film 20 is then sent to the drying chamber 15 and the cooling chamber 16, and wound around the winding shaft 51 in the winding chamber 17. The trimmed side edges of the film 20 is broken into fragments by the crusher 44 and used again as dope chips.

The film 20 to be wound around the winding shaft 52 should preferably be at least loom long in the longitudinal direction (casting direction). Additionally, the film 20 is 600 mm width or more preferably, and even preferably in the rage of 1400-2500 mm width. It is to be noted that the present invention is effective for the manufacture of the wide films with not less than 2500 mm width. Additionally, the present invention is also applicable to the manufacture of thin films with 15-100 μm thickness.

As shown in FIG. 2, in the casting process, the dope 21 out of the die 30 forms the bead 21a between the discharge slit 30a and the peripheral surface 32a. The suction force from the opening 71b of the decompression chamber 36 reduces the air pressure on the back side of the bead 21a to a predetermined value (by 100 Pa or more) with respect to the front side of the bead 21a. Accordingly, the casting film 33 will be kept in close contact with the drum 32 even in the high speed casting process. This pressure reduction produces airflow toward the opening 71b on the back side of the bead 21a.

Additionally, in the casting process, the preventive solution at the temperature of 30-35° C. is supplied from the supply port 61c at the flow rate of 0.15-0.22 ml/min. The preventive solution flows down the wall surface 30b and reaches the side ends of the discharge slit 30a. Consequently, the preventive solution proceeds to the side end areas of the bead 21a around the discharge slit 30a, and flows to the drum 32 together with the bead 21a. At this moment, the airflow on the back side of the bead 21a toward the decompression chamber 36 is blocked by the die 30 and the bead 21a itself. Therefore, the preventive solution on the front side of the bead 21a is hardly blown toward the decompression chamber 36.

Additionally, each of the nozzles 61a, 61b is placed to keep predetermined clearances CL1 and CL2 between the supply port 61c and the bead 21a. This arrangement prevents the preventive solution out of the nozzles 61a, 61b from being blown in the airflow around the side ends 21b of the bead 21a. More clearly, this nozzle arrangement prevents the film surface defects resulting from the preventive solution blown into the decompression chamber 36.

The clearance CL1 should not be greater than 5 mm preferably, and not be greater than 3 mm more preferably. Also, the clearance CL2 should not be greater than 5 mm preferably, and more preferably not less than 1 mm but not greater than 3 mm.

In the solution casting method of the present invention, the dope can be cast by either a simultaneous co-casting method in which two or more kinds of dope are co-cast at once and layered, or by a sequential co-casting method in which several kinds of dope are co-cast sequentially and layered. Alternatively, these co-casting methods may be combined. The simultaneous co-casting method can be conducted with a feed block attached die or a multi-manifold die, provided, however, that at least one of the layers on the ambient air side and the support side accounts for 0.5-30% of the film's total thickness. It is preferred in the sequential co-casting method, on the other hand, that the high viscosity dope wrapped by the low viscosity dope when the dopes are cast on the support, and that the exterior dope of the bead contains more alcohol than the interior dope.

The shape of the nozzles 61a, 61b is not limited to a circle, but may be an oval or the like.

Additionally, a casting band between two rotating rollers may be used in place of the drum 32.

Next, the ingredients of the dope 21 are explained. In the present embodiment, cellulose acylate is used as the polymer. A preferable cellulose acylate is cellulose triacetate (TAC). More preferable is cellulose triacetate whose degree of acyl substitution for the hydroxyl groups on the cellulose structure satisfies the following general formulas (I) to (III),

2.5≦A+B≦3.0 (I)

0≦A≦3.0 (II)

0≦B≦2.9 (III),

wherein A+B represents the degree of acyl substitution for the hydrogen atoms in the hydroxyl group on the cellulose structure, while A represents the degree of substitution of acetyl groups, and B represents the degree of substitution of acyl groups with a carbon atom number from 3 to 22. It is preferred that the particles of 0.1-4 mm make up 90 wt. % or more of TAC. However, the polymer is not limited to cellulose acylate, but may be cellulose acetate, propionate, and cellulose acetate butyrate.

The β-1,4 bonded glucose unit on the cellulose structure has hydroxyl free groups at 2^{nd}, 3^{rd}, and 6^{th} positions. Cellulose acylate is a polymer in which these hydroxyl free groups are partly or fully esterified by acyl groups with a carbon number of 2 or higher. The degree of acyl substitution expresses the rate of the esterified hydroxyl groups on the cellulose structure (where a degree 1 expresses 100% esterification) at each of the 2^{nd}, 3^{rd}, and 6^{th} positions.

The degree of full acylation substitution, in other words the sum of DS2+DS3+DS6, is preferably in the range of 2.00 to 3.00, and more preferably 2.22 to 2.90, and even preferably 2.40 to 2.88. In addition, the value of DS6/(DS2+DS3+DS6) is preferably not less than 0.28, and more preferably not less than 0.30, and even preferably in the range of 0.31 to 0.34. Here, DS2 expresses the rate of acyl substitution for hydrogen in the hydroxyl groups at the 2^{nd} position in the glucose unit (hereinafter, 2^{nd} position acyl substitution degree). Similarly, DS3 expresses the rate of acyl substitution for hydrogen in the hydroxyl groups at the 3^{rd} position in the glucose unit (hereinafter, 3^{rd} position acyl substitution degree), and DS6 expresses the rate of acyl substitution for hydrogen in the hydroxyl groups at the 6^{th} position in the glucose unit (hereinafter, 6^{th} position acyl substitution degree).

In the present invention, cellulose acylate may be composed of either one kind of acyl groups, or two or more kinds thereof. It is preferred, when two or more kinds of acyl groups are used, that one of them is an acetyl group. When the sum of the degrees of substitution of acetyl groups for the hydroxyl groups at the 2^{nd}, 3^{rd} and 6^{th} positions is represented by DSA, and the sum of the degrees of substitution of acyl groups for the hydroxyl groups at the positions other than 2^{nd}, 3^{rd}, and 6^{th} positions is represented by DSB, the value of DSA+DSB is preferably in the range of 2.22 to 2.90, and more preferably the range of 2.40 to 2.88.

DSB is preferably not less than 0.30, and more preferably not less than 0.7. Additionally, it is preferred that the substitution groups at the 6^{th} position account for not less than 20% of DSB, and preferably not less than 25%, and more preferably not less than 30%, and even preferably not less than 33%. The value of DSA+DSB at the 6^{th} position is preferably not less than 0.75, and more preferably not less than 0.80, and still more preferably not less than 0.85. Cellulose acylate with such a composition provides excellent solubility in the dope. Particularly, if a non-chlorine organic solvent is used together, the dope will become low in viscosity and excellent in both solubility and filterability.

Cellulose, the raw material of cellulose acylate, may be made from cotton pulps or cotton linters.

The acyl group with a carbon number of 2 and higher in cellulose acylate is not limited particularly, and may be either an aliphatic group or an aryl group. Such an acyl group may be, for example, alkylcarbonyl ester of cellulose, alkenylcarbonyl ester of cellulose, aromatic carbonyl ester of cellulose, and aromatic alkylcarbonyl ester of cellulose, and each of them may have further substitutents. Exemplary substitutents are a propionyl group, a butanoyl group, a pentanoyl group, a hexanoyl group, an octanoyl group, a decanoyl group, a dodecanoyl group, a tridecanoyl group, a tetradecanoyl group, a hexadecanoyl group, an octadecanoyl group, an isobutanoyl group, a t-butanoyl group, a cyclohexane carbonyl group, an oleoyl group, a benzoyl group, a naphthyl carbonyl group, and a cynnamoyl group. Preferable among these are the propionyl group, the butanoyl group, the dodecanoyl group, the octadecanoyl group, the t-butanoyl group, the oleoyl group, the benzoyl group, the naphthyl carbonyl group, and the cynnamoyl group, and more preferable are the propionyl group and the butanoyl group.

The solvent for the dope may be aromatic hydrocarbon (benzene or toluene, for example), halogenated hydrocarbon (dichloromethane or chlorobenzene, for example), alcohol (methanol, ethanol, n-propanol, n-butanol, or diethylene glycol, for example), ketone (acetone or methyl ethyl ketone, for example), and ether (methyl acetate, ethyl acetate, or propyl acetate, for example). It is to be understood that the dope is a polymer solution or a dispersed solution composed of the solvent and the dissolving or dispersing polymers.

The above halogenated hydrocarbon preferably has a carbon atom number from 1 to 7, and highly preferred of such halogenated hydrocarbon is dichloromethane. In light of the solubility of TAC, the peeling condition of the casting film from the support, and the properties of the film product such as mechanical strength and optical character, one or more kinds of alcohol with a carbon atom number from 1 to 5 may be added to dichloromethane. A preferred content of the alcohol is 2-25 wt. % to the whole amount of the solution, and 5-20 wt. % is more preferable. The alcohol will be methanol, ethanol, n-propanol, isopropanol, n-butanol and such, and preferable among these are methanol, ethanol, n-butanol, and a mixture thereof.

In view of the environmental impacts, there is a move to avoid using dichloromethane for the solvent recently. In this case, the solvent may be made of ether with a carbon atom number from 4 to 12, ketone with a carbon atom number from 3 to 12, ester with a carbon atom number from 3 to 12, alcohol with a carbon atom number from 1 to 12, or a mixture thereof. For example, a mixture of methyl acetate, acetone, ethanol, and n-butanol can be used for the solvent. The above ether, ketone, ester, and alcohol could have a cyclic structure. Also, the solvent can be made of a compound having two or more ester functional groups or alcohol functional groups (i.e., —O—, —CO—, —COO—, and —OH).

Cellulose acylate is explained in detail in the Japanese Patent Laid-open Publication No. 2005-104148, paragraph 0140 through 0195, and these descriptions may be applied to the present invention. Similarly, such additives as solvents, plasticizers, deterioration inhibitors, ultraviolet ray absorbers (UV solutions), retardation (optical anisotropy) controllers, dyestuffs, matting agents, releasing agents, and release improvers are also explained in detail in the Publication No. 2005-104148, paragraph 0196 through 0516, and these descriptions may be applied to the present invention.

The Japanese Patent Laid-open Publication No. 2005-104148 also describes, in paragraph 0617 through 0889, such details of the solution casting method as the structures of the casting die, the decompression chamber, and support to the details of the co-casting process, the film peeling process, and the tentering process, film drying conditions, a film handling method, curling, the film winding method after planarity correction, the solvent recovery method, and the film recovery method. These descriptions may also be applied to the present invention.

(Cyclic Polyolefin)

The dope 21 is made of cellulose acylate in the above embodiment. The present invention, however, is not limited to this, and a cyclic polyolefin can be used in place of cellulose acylate.

The cyclic polyolefin is a polymer having a cyclic olefin structure. A suitable cyclic polyolefin for the present invention is a norbornene-type polymer, a monocyclic olefin polymer, a cyclic conjugated giene polymer, a vinyl alicyclic hydrocarbon polymer, or hydride compounds of each of these. A suitable polymer for the present invention is a cyclic polyolefin which is an addition (co-)polymer containing at least one kind of the repeating unit expressed by the following chemical formula F2, and a ring polyolefin addition (co-)polymer further containing at least one kind of the repeating units expressed by the following chemical formula F1. Additionally, a ring-opening (co-)polymer containing at least one kind of the repeating unit expressed by the following chemical formula F3 is also suitable.

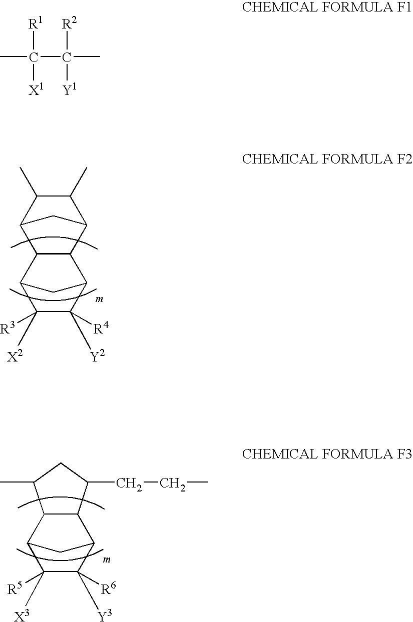

In these formulas, m is an integer 0 through 4, while R¹ to R⁶ are a hydrogen atom or a hydrocarbon group with a carbon number from 1 to 10, X¹ to X³ and Y¹ to Y³ are any of a hydrogen atom, a hydrocarbon group with a carbon number from 1 to 10, a halogen atom substitution hydrocarbon group with a carbon number from 1 to 10, —(CH₂)ₙCOOR¹¹, —(CH₂)ₙOCOR¹², (CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ, —(CH₂)ₙW, and (—CO)₂O or (—CO)₂NR¹⁵ composed of a combination of X¹ and Y¹ or X² and Y² or X³ and Y³. Here, R¹¹ to R¹⁵ are a hydrogen atom or a hydrocarbon group with a carbon number from 1 to 20, Z is a hydrocarbon group or a halogen substitution hydrocarbon group, W is SiR¹⁶ₚD₃₋ₚ (in which R¹⁶ is a hydrocarbon group with a carbon number from 1 to 10, D is a halogen atom —OCOR¹⁶ or —OR⁶, p is an integer 0 through 10), and n is an integer 0 through 10.

By adding a highly polarizable functional group to the substituents of X¹ to X³ and Y¹ to Y³, the retardation of the film toward the thick direction (Rth) is increased, and the in-plane retardation of the film (Re) will also be developed easily. Such a film is then stretched during the film manufacturing process, and Re and Rth are both further increased.

As disclosed in Japanese Patent Laid-open Publication No. 10-7732, Japanese National Publication No. 2002-504184, United States Patent Application Publication No. 2004/0229157 A1, and International Publication No. WO2004/070463A1, the norbornene-type addition (co)polymer is made through the addition polymerization of polycyclic unsaturated norbornene-type compounds. Alternatively, this addition polymerization is conducted with the polycyclic unsaturated norbornene-type compound and a diene compound composed of either a conjugated diene, a non-conjugated diene, or a linear giene. The conjugated diene compound may be ethylene, propylene, butane, butadiene, and isoprene. The non-conjugated diene compound may be ethylidene norbornene. The linear diene compound may be acrylonitrile, acrylic acid, Methacrylic acid, maleic anhydride, acrylic ester, methacrylic ester, maleimide, vinyl acetate, and vinyl chloride. The norbornene-type addition (co)polymer is commercially available under the name of APEL (product name: Mitsui Chemicals, Inc.) with several variations in grass transition temperature (Tg). Some of them are APL8008T (Tg: 70° C.), APL6013T (Tg: 125° C.), and APL6015T (Tg: 145° C.). Also, there are the norbornene-type addition (co)polymer pellet products such as TOPAS8007, TOPAS6013, TOPAS6015 (from Polyplastics Co., Ltd), and Appear3000 (from Perrania S.p.A).

The norbornene-type hydride polymer compound is disclosed in Japanese Patent Laid-open Publications No. 01-240517, No. 07-196736, No. 60-26024, No. 62-19801, No. 2003-159767, and No. 2004-309979, and is made through the addition polymerization or the metathesis ring-opening polymerization of the polycyclic unsaturated compounds and subsequent hydrogenation. In a preferred norbornene-type polymer for the present invention, R⁵ and R⁶ are a hydrogen atom or —CH₃ preferably, X³ and Y³ are a hydrogen atom, Cl, or —COOCH₃ preferably, and other groups are selected appropriately. Such a norbornene-type polymer is commercially available under the names of ARTON G and ARTON F (JSR Corporation), and ZEONOR ZF14, ZEONOR ZF16, ZEONEX 250, and ZEONEX 280 (ZEON Corporation), and these products can be used in the present invention.

### Solvent

The solvent is not limited particularly, but should be a good solvent, in other words, the solvent that can dissolve the cyclic polyolefin. A preferable solvent is a chlorine compound such as dichloromethane or chloroform, a chain hydrocarbon, a cyclic hydrocarbon, an aromatic hydrocarbon, a compound of ester, ketone, and/or ether all these having a carbon atom number from 3 to 12. The ester, ketone, and ether could have a cyclic structure. The chain hydrocarbon with a carbon atom number from 3 to 12 may be hexane, octane, isooctane, and decane. The cyclic hydrocarbon with a carbon atom number from 3 to 12 may be cyclopentane, cyclohexane, and their derivatives. The aromatic hydrocarbon with a carbon atom number from 3 to 12 may be benzene, toluene, and xylene. The ester with a carbon atom number from 3 to 12 may be ethyl formate, propyl formate, pentyl formate, methyl acetate, ethyl acetate, and pentyl acetate, The ketone with a carbon atom number from 3 to 12 may be acetone, methyl ethyl ketone, diethyl ketone, diisobutyl ketone, cyclopentanone, cyclohexanone, and methyl cyclohexanone. The ether with a carbon atom number from 3 to 12 may be diisopropyl ether, dimethoxymethane, dimethoxyethane, 1,4-dioxane, 1,3-dioxolan, tetrahydrofuran, anisole, and phenetole. An exemplary organic solvent with two or more kinds of functional groups is 2-ethoxyethyl acetate, 2-methoxy ethanol, and 2-butoxy ethanol. The boiling point of the organic solvent is preferably from 35° C. to 150° C. Additionally, the solvent can be a mixture of two or more kinds of compounds for the purpose to adjust the dope's dryability, viscosity, and other properties. In this, case, the solvent can contain a poor solvent.

The poor solvent will be selected according to the polymer used. For example, if the good solvent is chloride organic solvent, an alcohol can be used as the poor solvent. The alcohol can have either straight-chain, branch, or cyclic structure, and a saturated aliphatic hydrocarbon is preferred. Also, the alcohol can be primary, secondary, or tertiary. Such an alcohol is, for example, methanol, ethanol, 1-propanol, 2-propanol, 1-butanol, 2-butanol, t-butanol, 1-pentanol, 2-methyl-2-butanol, and cycrohexanol. The alcohol may be a fluorinated alcohol, such as 2-fluoroethanol, 2,2,2-trifluoroethanol; or 2,2,3,3-tetrafluoro-1-propanol. As the poor solvent, a monohydroxy alcohol is highly preferred because it reduces the peeling resistance. Although it depends on the good solvent used, the favorable alcohol has the boiling point at 120° C. or less in view of the dryability, and more favorable is a monohydroxy alcohol with a carbon number from 1 to 6, and still more favorable is an alcohol with a carbon number from 1 to 4. Particularly, a preferable mixed solvent for the cyclic polyolefin dope is dichloromethane as a main component and one or more of methanol, ethanol, propanol, isopropanl, and butanol as the poor solvent.

### Additives and Other Film Ingredients

Various additives and other film ingredients can be added for many purposes to the cyclic polyolefin dope. The additives will be (1) a deterioration inhibitor, (2) a ultraviolet ray absorber (3) a retardation (optical anisotropy) controller, (4) a release improver, (5) a plasticizer, (6) an infrared ray absorber, (7) fine particles, and the like. These additives can be solid or oily, and are not limited by their melting points and boiling points. For example, a mixture of two ultraviolet ray absorbers having the boiling point greater or equal to 20° C. and the boiling point less or equal to 20° C. respectively can be used, and so does a mixture of the deterioration inhibitors. The infrared ray absorber (or, infrared absorptive dye) can be any of those disclosed in Japanese Patent Laid-open Publication No. 2001-194522. Additionally, the additives can be introduced at any stage in the production process of the cyclic polyolefin dope, or an additive adding step may be provided at the end of the dope production process. The amount of each additive is not limited particularly, and is determined properly for the desired function. If a multilayered cyclic polyolefin film is to be manufactured, the additives can be different in kind and amount at each layer.

(1) Deterioration Inhibitor

It is possible in the present invention to add a common deterioration inhibitor (antioxidant) to the dope. The antioxidant can be phenol compound or hydroquinonic compound, such as 2,6-di-t-butyl, 4-methyl phenol, 4,4′-thiobis-(6-t-butyl-3-methyl phenol), 1,1′-bis(4-hydroxyphenyl)cyclohexane, 2,2′-methylenebis(4-ethyl-6-t-butylphenol), 2,5-di-t-butylhydroquinone, and pentaerythrityl-tetrakis[3-(3,5-di-t-butyl-4-hydroxyphenyl)propionate]. Also, preferably used is a phosphorous antioxidant, such as tris(4-methoxy-3,5-diphenyl)phosphyte, tris(nonylphenyl)phosphyte, tris(2,4-di-t-butylphenyl)phosphyte, bis(2,6-di-t-butyl-4-methylphenyl)pentaerythritol diphosphyte, and bis(2,4-di-t-butylphenyl) pentaerythritol diphosphyte. A preferred additive amount of the antioxidant is 0.05-5.0 pts.wt with respect to 100 pts.wt of the cyclic polyolefin.

(2) Ultraviolet Ray Absorber

If the finished film is to be used in a polarizing filter or used with a liquid crystal device, it is preferred to add an ultraviolet ray absorber to the dope for the purpose to prevent the degradation of the polarizing filter and the liquid crystal. For a good absorbing power to the ultraviolet ray at or below 370 nm wavelength and for a good contrast of the liquid crystal device, the ultraviolet ray absorber should preferably be less active to the visible light at or above 400 nm wavelength. A preferred ultraviolet ray absorber may be a hindered phenol compound, an oxybenzophenone compound, a benzotriazole compound, a salicylate acid ester compound, a benzophenone compound, a cyanoacrylate compound, and a nickel complex salt compound.

The hindered phenol compound may be 2,6-di-tert-butyl-p-cresol, pentaerythrithyl-tetrakis[3-(3,5-di-tert-butyl-4-hydroxyphenyl)propionate], N,N′-hexamethylenebis(3,5-di-tert-butyl-4-hydroxy-hydrocinnamido), 1,3,5-trimethyl-2,4,6-tris(3,5-di-tert-butyl-4-hydroxybenzil)benzene, and tris-(3,5-di-tert-butyl-4-hydroxybenzil)-isocyanurate. The benzotriazole compound may be 2-(2′-hydroxy-5′-methylphenyl) benzotriazole, 2,2′-methylenebis(4-(1,1,3,3-tetramethylbutyl)-6-(2H-benzotriazole-2-yl)phenol), (2,4-bis-(n-octylthio)-6-(4-hydroxy-3,5-di-tert-butylanilino)-1,3,5-triazine, triethyleneglycol-bis[3-(3-tert-butyl-5-methyl-4-hydroxyphenyl)propionate], N,N′-hexamethylenebis(3,5-di-tert-butyl-4-hydroxy-hydrocinnamido), 1,3,5-trimethyl-2,4,6-tris(3,5-di-tert-butyl-4-hydroxybenzil)benzene, 2(2′-hydroxy-3′,5′-di-tert-butylphenyl)-5-chlorbenzotriazole, (2(2′-hydroxy-3′,5′-di-tert-amylphenyl)-5-chlorbenzotriazole, 2,6-di-tert-butyl-p-cresol, and pentaerythrithyl-tetrakis[3-(3,5-di-tert-butyl-4-hydroxyphenyl)propionate]. The amount of the ultraviolet ray absorber is preferably in the range of 1 ppm to 1.0% with respect to the amount of the cyclic polyolefin, and more preferably in the range of 10-1000 ppm.

(3) Retardation Controller

It is possible to use a compound having at least two aromatic rings as a retardation controller to give a desired retardation to the film. The amount of the retardation controller, where needed, will be in the range of 0.05-20 pts.wt with respect to 100 pts.wt of the cyclic polyolefin, and preferably in the range of 0.1-10 pts.wt, and even preferably in the range of 0.2-5 pts.wt, and still more preferably in the range of 0.5-2 pts.wt. It is also possible to use two or more retardation controllers at once. Preferably, the retardation controller has the absorbing power-peak at the wavelength of 250-400 nm, and has almost no absorbing power to the visible range.

The aromatic ring in the retardation controller can be an aromatic hydrocarbon ring or an aromatic hetero ring. A preferred aromatic hydrocarbon ring is a 6-membered ring (i.e., benzene ring). Generally, the aromatic hetero ring is unsaturated. A preferred aromatic hetero ring is 5-, 6-, and 7-membered rings, and the 5- and 6-membered rings are more preferable. The aromatic hetero ring tends to have a largest number of double bonds. The hetero atom is preferably a nitrogen atom, an oxygen atom, and a sulfur atom, and the particularly preferable is the nitrogen atom. The exemplary aromatic hetero ring is a furan ring, a thiophen ring, a pyrrole ring, an oxazole ring, an isoxazole ring, a thiazole ring, an isothiazole ring, an imidazole ring, a pyrazole ring, a furazane ring, a triazole ring, a pyran ring, a pyridine ring, a pyridazine ring, a pyrimidine ring, a pyrazine ring, and a 1,3,5-triazine ring. A preferred aromatic ring is the benzene ring, the furan ring, the thiophen ring, the pyrrole ring, the oxazole ring, the thiazole ring, the imidazole ring, the triazole ring, the pyridine ring, the pyrimidine ring, the pyrazine ring, and the 1,3,5-triazine ring, and especially preferable among these is the 1,3,5-triazine ring. In particular, the one disclosed in Japanese Patent Laid-open Publication No. 2001-166144 is used favorably, for example.

It is preferred that the retardation controller contains 2 to 20 aromatic rings, and more preferably 2 to 12 aromatic rings, and even preferably 2 to 8 aromatic rings, and still more preferably 2 to 6 aromatic rings. The aromatic rings will form either a fused ring (a), a single bond (b), or be bonded through a linking group (c), and the chemical bond of the compound can be any of these. It is obvious that these chemical bonds are for the aromatic ring, and thus a spiro bond is never formed.

The fused ring of (a), in other words the fused ring of two or more aromatic rings may be an indene ring, a naphthalene ring, an azulene ring, a fluorene ring, a phenanthrene ring, an anthracene ring, an acenaphthylene ring, a biphenylene ring, a naphthacene ring, a pyrene ring, an indole ring, an isoindole ring, a benzofuran ring, a benzothiophene ring, an indolizine ring, a benzoxazole ring, a benzothiazole ring, a benzoimidazole ring, a benzotriazole ring, a purine ring, an indazole ring, a chromene ring, a quinoline ring, an isoquinoline ring, a quinolizine ring, a quinazoline ring, a cinnoline ring, a quinoxaline ring, a phthalazine ring, a pteridine ring, a carbazole ring, an acridine ring, a phenanthridine ring, a xanthene ring, a phenazine ring, a phenothiazine ring, a phenoxathiin ring, a phenoxazine ring, and a thiantren ring. Especially preferable among these are the naphthalene ring, the azulene ring, the indole ring, the benzoxazole ring, the benzothiazole ring, the benzoimidazole ring, the benzotriazole ring, and the quinoline ring.

The single bond (b) is preferably a bond of carbon atoms of adjacent aromatic rings. It is also possible to bond two aromatic rings through two or more single bonds, and form an aliphatic ring or a nonaromatic heterocyclic ring between the two aromatic rings.

Similar to the single bond (b), the linking group (c) is also preferably a bond of carbon atoms of adjacent aromatic rings. A preferred linking group is an alkylene group, an alkenylene group, an alkynylene group, —CO—, —O—, —NH—, —S—, or a combination of these. Such combinations for the linking group are shown below. The left and right sides of the linking group can be reversed.

c1: —CO—O—

c2: —CO—NH—

c3: -alkylene-O—

c4: —NH—CO—NH—

c5: —NH—CO—O—

c6: —O—CO—O—

c7: —O-alkylene-O—

c8: —CO-alkenylene-

c9: —CO-alkenylene-NH—

c10: —CO-alkenylene-O—

c11: -alkylene-CO—O-alkylene-O—CO-alkylene-

c12: —O-alkylene-CO—O-alkylene-O—CO-alkylene-O—

c13: —O—CO-alkylene-CO—O—

c14: —NH—CO-alkenylene-

c15: —O—CO-alkenylene-

These aromatic rings and linking groups could have substituents. The substituents may be halogen atoms (F, Cl, Br, I), hydroxy groups, carboxy groups, cyano groups, amino groups, nitro groups, sulfo groups, carbamoyl groups, sulfamoyl groups, ureide groups, alkyl groups, alkenyl groups, alkynyl groups, aliphatic acyl groups, aliphatic acyloxy groups, alkoxy groups, alkoxycarbonyl groups, alkoxycarbonylamino groups, alkylthio groups, alkylsulfonyl groups, aliphatic amide groups, aliphatic sulfonamide groups, aliphatic substituted amino groups, substituted aliphatic carbamoyl groups, substituted aliphatic sulfamoyl groups, substituted aliphatic ureide groups, and nonaromaticity heterocyclic groups.

The preferable alkyl group has a carbon atom number from 1 to 8. A chain alkyl group is more preferable than a cyclic alkyl group, and a straight-chain alkyl group is preferred especially. Additionally, the alkyl group could have substituents, which may be hydroxy, carboxy, alkoxy groups, alkyl substituted amino groups. The alkyl group (including alkyl substituted group) may be a methyl group, an ethyl group, an n-butyl group, an n-hexyl group, a 2-hydroxyethyl group, a 4-carboxybutyl group, a 2-methoxyethyl group, and a 2-diethylaminoethyl group.

The preferable alkenyl group has a carbon atom number from 2 to 8. A chain alkenyl group is more preferable than a cyclic alkenyl group, and a straight-chain alkenyl group is preferred especially. Additionally, the alkenyl group could have such substituents as, for example, vinyl, allyl, and 1-hexenyl. The preferable alkynyl group has a carbon atom number from 2 to 8. A chain alkynyl group is more preferable than a cyclic alkynyl group, and a straight-chain alkynyl group is preferred especially. Additionally, the alkynyl group could have such substituents as, for example, ethynyl, 1-butynyl, and 1-hexynyl.

The preferable aliphatic acyl group has a carbon atom number from 1 to 10. Such an aliphatic acyl group may be acetyl, propanoyl, and butanoyl. The preferable aliphatic acyloxy group has a carbon atom number from 1 to 10. Such an aliphatic acyloxy group may be acetoxyl, for example. The preferable alkoxy group has a carbon atom number from 1 to 8. Additionally, the alkoxy group could be a substituted alkoxy group which contains the substituents of alkoxy or such. The alkoxy group (including the substituted alkoxy group) is, for example, a methoxy group, an ethoxy group, a butoxy group, and a methoxy ethoxy group. A preferable alkoxycarbonyl group has a carbon atom number from 2 to 10. The alkoxycarbonyl group may be a methoxycarbonyl group and an ethoxycarbonyl group, for example. The preferable alkoxycarbonylamino group has a carbon atom number from 2 to 10. Such an alkoxycarbonylamino group may be a methoxycarbonylamino group and an ethoxycarbonylamino group, for example.

The preferable alkylthio group has a carbon atom number from 1 to 12. Such an alkylthio group may be a methylthio group, an ethylthio group, and an octylthio group. The preferable alkylsulfonyl group has a carbon atom number from 1 to 8 preferably. Such an alkylsulfonyl group may be a methanesulfonyl group and an ethanesulfonyl group, for example. The preferable aliphatic amide group has a carbon atom number from 1 to 10. Such an aliphatic amide group is acetamide, for example. The preferable aliphatic sulfonamide group has a carbon atom number from 1 to 8. Such an aliphatic sulfonamide group may be a methansulfonamide group, a butanesulfonamide group, and n-octanesulfonamide, for example. The preferable substituted aliphatic amino group has a carbon atom number from 1 to 10. Such a substituted aliphatic amino group may be a dimethylamino group, a diethylamino group, and 2-carboxyethylamino, for example.

The preferable substituted aliphatic carbamoyl group has a carbon atom number from 2 to 10. Such a substituted aliphatic carbamoyl group may be a methylcarbamoyl group and a diethylcarbamoyl group, for example. The preferable aliphatic substituted sulfamoyl group has a carbon atom number from 1 to 8. Such a substituted aliphatic sulfamoyl group may be a methylsulfamoyl group and a diethylsulfamoyl group, for example. The preferable substituted aliphatic ureide group has a carbon atom number from 2 to 10. Such a substituted aliphatic ureide group is a methyureide group, for example.

The nonaromaticity heterocyclic group may be, for example, a piperidino group and a morpholino group. It is preferred that the retardation controller has a molecular weight of 300 to 800.

Preferably used for the retardation controller is a compound with 1,3,5-triazine rings, or a rod-like compound having a linear molecular structure. The linear molecular structure means that the molecules of the rod-like compound show a linear structure in the thermodynamically most stable state. The thermodynamically most stable state can be found by the crystal structure analysis or the molecular orbital calculation. For example, the molecular orbital is calculated with a molecular orbital calculation software (such as WinMOPAC2000 from FUJITSU Limited), and the molecular structure to produce the lowest heat of formation is obtained. The molecular structure can be regard as linear when the angle between the bonds in the main chain is 140 degrees or more in the thermodynamically most stable state found through the above mentioned calculation.

A preferable rod-like compound with at least two aromatic rings is the compound expressed by the following general formula (IV),

Ar¹-L¹-Ar² (IV).

In the above formula (IV), Ar¹ and Ar² are the aromatic groups of either the same or different kind. These aromatic groups may be an aryl group (aromaticity hydrocarbon group), a substituted aryl group, an aromaticity heterocyclic group, and a substituted heterocyclic group. The aryl group and the substituted aryl group are more preferable than the aromaticity heterocyclic group and the substituted heterocyclic group. The hetero ring of the aromaticity heterocyclic group is unsaturated generally. A preferred aromatic hetero ring is 5-, 6-, and 7-membered rings, and the 5- and 6-membered rings are more preferable. The aromaticity hetero ring tends to have a largest number of double bonds. The hetero atom is preferably a nitrogen atom, an oxygen atom, and a sulfur atom, and the particularly preferable is the nitrogen atom or the sulfur atom. The exemplary aromatic ring of the aromatic groups is a benzene ring, a furan ring, a thiophene ring, a pyrrole ring, an oxazole ring, a thiazole ring, an imidazole ring, a triazole ring, a pyridine ring, or a pyrimidine ring, and especially preferable among these is the benzene ring.

L¹ in the formula (IV) is a diatomic linking group composed of an alkylene group, an alkenylene group, an alkynylene group, —O—, —CO—, or a combination of these groups. The alkylene group could have a cyclic structure. A preferred cyclic alkylene group is cyclohexylene, and especially preferred is 1,4-cyclohexylene. As for a chain alkylene group, a straight-chain alkylene group is more preferable than the alkylene group with branches. The carbon atom number of the alkylene group is from 1 to 20 preferably, from 1 to 15 more preferably, from 1 to 10 more preferably, from 1 to 8 still more preferably, and from 1 to 6 most preferably.

The alkenylene group and the alkynylene group should rather have a chain structure than a cyclic structure. Additionally, a straight-chain structure is more preferable than a branched structure. The carbon atom number of each of the alkenylene group and the alkynylene group is from 2 to 10 preferably, from 2 to 8 more preferably, from 2 to 6 more preferably, from 2 to 4 still more preferably, and from 2 (vinylene or ethynylene) most preferably. The carbon atom number of the arylene group is from 6 to 20 preferably, from 6 to 16 more preferably, and from 6 to 12 still more preferably. It is preferred that Ar¹ and Ar² form an angle of 140 degrees or more respectively with L¹ in the molecular structure expressed by the formula (IV).

A compound expressed by the following general formula (V) is more preferable to the rod-like compound,

Ar¹-L²-X-L³-Ar² (V).

In the formula (V), Ar¹ and Ar² are the aromatic groups of either the same or different kind. The definition and example of the aromatic groups are the same as those in the formula (IV).

Each of L² and L³ in the formula (V) is a diatomic linking group composed of an alkylene group, —O—, —CO—, or a combination of these groups. The alkylene group should rather have a chain structure than a cyclic structure. Additionally, a straight-chain structure is more preferable than a branched structure. The carbon atom number of the alkylene group is from 1 to 10 preferably, from 1 to 8 more preferably, from 1 to 6 more preferably, from 1 to 4 still more preferably, and from 1 or 2 (methylene or ethylene) most preferably. It is particularly preferred that L² and L³ are —O—CO— or —CO—O—. X in the formula (V) is 1,4-cyclohexylene, vinylene, or ethynylene. Additionally, it is possible to use two or more kinds of rod-like compounds each of which has a maximum absorption wavelength (λ max) at or below 250 nm in the ultraviolet absorption spectrum of the solution. A preferred additive amount of the retardation controller is 0.1-30 wt. % to the cyclic polyolefin, and a more preferred amount is 0.5-20 wt. %.

(4) Release Improver

Some of the surface active agents (or, so-called surfactants) prove to be effective remarkably as the release improver that reduces the peeling resistance of the cyclic polyolefin films. A preferable release improver will be, for example, a phosphoric ester surfactant, a surfactant of either carboxylic acid or salt of carboxylic acid, a surfactant of either sulfone acid or salt of sulfone acid, and a sulfate surfactant. Also preferable is a fluorinated surfactant in which a part of the hydrogen atoms bonded to the hydrocarbon chain in the above surfactant is substituted with fluorine atoms. The following are exemplary release improvers.

RZ-1 C₈H₁₇O—P(═O)— (OH)₂

RZ-2 C₁₂H₂₅O—P(═O)— (OK)₂

RZ-3 C₁₂H₂₅OCH₂CH₂O—P(═O)— (OK)₂

RZ-4 C₁₅SH₃₁(OCH₂CH₂)₅O—P(═O)—(OK)₂

RZ-5 {C₁₂H₂₅—O—(CH₂CH₂O)₅}₂—P(═O)—OH

RZ-6 (C₁₈H₃₅ (OCH₂CH₂)₈O)₂—P(═O)—ONH₄

RZ-7 (t-C₄H₉)₃—C₆H₂—OCH₂CH₂O—P(═O)— (OK)₂

RZ-8 (iso-C₉H₁₉—C₆H₄—O—(CH₂CH₂O)₅—P(═O)—(OK)(OH)

RZ-9 C₁₂H₂₅SO₃Na

RZ-10 C₁₂H₂₅OSO₃Na

RZ-11 C₁₇H₃₃COOH

RZ-12 C₁₇H₃₃COOH.N(CH₂CH₂OH)₃

RZ-13 iso-C₈H₁₇—C₆H₄—O—(CH₂CH₂O)₃—(CH₂)₂SO₃Na

RZ-14 (iso-C₉H₁₉)₂C₆H₃—O—(CH₂CH₂O)₃—(CH₂)₄SO₃Na

RZ-15 triisopropyl naphthalenesulfone sodium

RZ-16 tri-t-butyl naphthalenesulfonate sodium

RZ-17 C₁₇H₃₃CON(CH₃)CH₂CH₂SO₃Na

RZ-18 C₁₂H₂₅—C₆H₄SO₃—NH₄

The additive amount of the release improver is 0.05-5 wt. % to the cyclic polyolefin preferably, and 0.1-2 wt. % more preferably, and 0.1-0.5 wt. % still more preferably.

(5) Plasticizer

As compared to the cellulose acetate, the cyclic polyolefin generally has less flexibility and, once formed into a film, it easily cracks under a bending stress and a shearing stress. Furthermore, when the cyclic polyolefin film is cut off to be optical products, the cut edge has cracks easily and produces chips. Contaminating the film, these chips cause optical defects in the optical products. Such drawbacks can be overcome by the introduction of the plasticizer to the dope. The plasticizer will be, for example, a phthalic acid ester compound, a trimellitic acid ester compound, an aliphatic dibasic ester compound, an orthophosphoric ester compound, an acetate compound, a polyester/epoxidized ester compound, a ricinoleate compound, a polyolefin compound, and polyethyleneglycol compound.

An allowable compound for the plasticizer should preferably be a liquid with the boiling point at or above 200° C., at a room temperature and normal pressure.

Allowable aliphatic dibasic ester compounds are, for example, dioctyladipate (230° C./760 mmHg (approximately 101080 Pa)), dibutyladipate (145° C./4 mmHg (approximately 532 Pa)), di-2-ethylhexyladipate (335° C./760 mmHg (approximately 101080 Pa)), dibutyldiglycoladipate (230-240° C./2 mmHg (approximately 266 Pa)), di-2-ethylhexylazelate (220-245° C./4 mmHg (approximately 532 Pa)), and di-2-ethylhexylsebacate (377° C./760 mmHg (approximately 101080 Pa)). Allowable phthalate compounds are, for example, diethylphthalate (298° C./760 mmHg (approximately 101080 Pa)), diheptylphthalate (235-245° C./10 mmHg (approximately 1330 Pa)), di-n-octylphthalate (210° C./760 mmHg (approximately 101080 Pa)), and diisodecylphthalate (210° C./760 mmHg (approximately 101080 Pa). Allowable polyolefin compounds are, for example, paraffin waxes (average molecular weight of 330 to 600, melting point 45-80° C.) such as normal paraffin, isoparaffin, and cycloparaffin, liquid paraffins (JIS K2231ISOVG8, VG15, VG32, VG68, VG100, and such), paraffin pellets (melting points 56-58° C., 58-60° C., 60-62° C., and such), paraffin chloride, low-molecular-weight polyethylene, low-molecular-weight polypropylene, low-molecular-weight polyisobutene, hydrogenated polybutadiene, hydrogenated polyisoprene, and squalane.

The additive amount of the plasticizer is 0.5-40.0 wt. % to the cyclic polyolefin, 1.0-30.0 wt. % preferably, 3.0-20.0 wt. % more preferably. If the additive amount of the plasticizer is less than 0.5 wt. %, the expected plasticizing effect is hardly provided and the workability is not improved. If the additive amount is more than 40 wt. %, to the contrary, the plasticizer may possibly liquate after a ling time and cause such problems as optical unevenness and contamination of other components.

(7) Fine Particles

Fine particles may be added to the above cyclic polyolefines for the purpose to reduce the dynamic friction coefficient at the surface of the film product and, therefore, to reduce the stress to the film when the film is handled. The fine particles are not limited, but can be the particles of either organic or inorganic compounds.

Preferred inorganic compounds are silicon-containing compounds, such as silicon dioxide, titanium oxide, zinc oxide, aluminum oxide, barium oxide, zirconium oxide, strongthium oxide, antimony oxide, tin oxide, tin/antimony oxide, calcium carbonate, talc, clay, calcined kaolin, calcined calcium silicate, hydrated calcium silicate, aluminum silicate, magnesium silicate, and calcium phosphate. More preferable are silicon-containing inorganic compounds and silicon-containing metal oxides. In view of turbidity removal effect for the film, the silicon dioxide is particularly preferred. The silicon dioxide particles can be selected such commercial products as AEROSIL R972, R974, R812, 200, 300, R202, OX50, and TT600 (product names: NIPPON AEROSIL Co., Ltd). The zirconium oxide particles can be selected from such commercial products as AEROSIL R976 and R811 (product names: NIPPON AEROSIL Co., Ltd).

Preferred organic compounds are polytetrafluoroethylene, cellulose acetate, polystyrene, polymethylmethacrylate, polypropylmethacrylate, polymethylacrylate, polyethylene carbonate, and starch. The crushed fractions of these compounds can also be used. Additionally, the high polymer compounds made by a suspension polymerization method and the rounded high polymer compounds made by a spray dry method or a dispersion method can be used.

For the purpose to reduce the film haze to minimum, the primary average diameter of the fine particles is in the rage of 1-20000 nm, preferably in the rage of 1-10000 nm, and more preferably in the rage of 2-1000 nm, and even preferably in the rage of 5-500 nm. This primary average diameter can be calculated from the average size of the particles measured with a transmission electron microscope. As they often aggregate immediately after the purchase, the fine particles should be dispersed before use by a known method. By this dispersion, the secondary average diameter of the fine particles is preferably adjusted to the range of 200-1500 nm, and more preferably to the range of 300-1000 nm.

The additive amount of the fine particles should preferably account for 0.01-0.3 pts.wt with respect to 100 pts.wt of the cyclic polyolefin, and more preferably 0.05-0.2 weigh part, and even preferably 0.08-0.12 pts.wt.

It is preferred that the cyclic polyolefin film with the fine articles added has haze of 2.0% or less, and of 1.2% or less more preferably, and of 0.5% or less still more preferably. A preferred dynamic friction coefficient of the cyclic polyolefin film with the fine articles added is not greater than 0.8, and more preferably not greater than 0.5. The dynamic friction coefficient can be measured by a JIS or ASTM method using a steel ball. The haze can be measured with a haze measurement equipment, such as 1001DP (from NIPPON DENSHOKU INDUSTRIES Co., Ltd).

(Solidification Preventive Solution)

Next, the solidification preventive solution (or, preventive solution) in the dope 21 is explained in detail. The preventive solution, to be supplied on both side end areas 21a of the dope 21, should be composed of a good solvent for the dope 21 or a mixture of a good solvent and a poor solvent. The content of the poor solvent is preferably 20 wt. % or below, and more preferably 13 wt. % or below, to the whole mixture. The good and poor solvents, however, are not limited to the above. Additionally, the preventive solution should preferably contain the same ingredients as the good and poor solvents in the dope.

(Good Solvent)

If the polymer is cellulose acylate, a good solvent is aromatic hydrocarbon (benzene and toluene, for example), halogenated hydrocarbon (dichloromethane and chlorobenzene, for example), ester (methyl acetate, ethyl acetate, and propyl acetate, for example), and ether (tetrahydrofuran and methyl cellosolve). Preferable among these is the halogenated hydrocarbon with a carbon atom number from 1 to 7, and most preferable is dichloromethane.

(Poor Solvent)

If the polymer is cellulose acylate, a poor solvent is alcohol (methanol, ethanol, n-propanol, n-butanol, and diethylene glycol, for example) and ketone (acetone and methyl ethyl ketone, for example). Preferable among these is the alcohol with a carbon atom number from 1 to 12, and most preferable is methanol. It is to be noted that the good and poor solvents in the preventive solution can be a mixture of several compounds.

Whether a liquid compound is a good solvent or a poor solvent for a polymer is judged by mixing the polymer with this liquid compound such that the polymer accounts for 5 wt. % to the whole amount. Then, the liquid compound is considered as the good solvent if an insoluble matter does not remain. If an insoluble matter remains, to the contrary, the liquid compound is considered as the poor solvent.

Next, a working example of the present invention is explained. The composition and production of the polymer solution (dope) was as follows.

### Composition

The solid content (solute) that consisted of 89.3 wt. % of cellulose triacetate (2.8 degrees of substitution), 7.1 wt. % of a plasticizer A (triphenyl phosphate), and 3.6 wt. % of a plasticizer B (biphenyl diphenyl phosphate) was added to a mixture solvent of 87 wt. % of dichloromethane, 12 wt. % of methanol, and 1 wt. % of n-butanol, and they were then stirred and dissolved into the dope 21. The solid concentration of the dope 21 was adjusted to 19.3 wt. %. The dope 21 was filtered with a filter paper (#63LB from Toyo Roshi Co., Ltd), a sintered metal filter (06N from Nippon Seisen Co., Ltd, nominal pore diameter 10 μm), and a mesh filter consequently, and then put into the stock tank 11.

### Cellulose Triacetate

The above cellulose triacetate (TAC) contained not greater than 0.1 wt. % of remaining acetate, 58 ppm of Ca, 42 ppm of Mg, 0.5 ppm of Fe, 40 ppm of free acetate, and 15 ppm of sulfate ion. Additionally, the degree of acetyl substitution for the hydrogen in the 6^{th} position hydroxyl group was 0.91, and 32.5% of the whole acetyl groups was the substitutions of the hydrogen in the position 6 hydroxyl group. Acetone extraction of the TAC was 8 wt. %, and its ratio of weight average molecular weight to number average molecular weight was 2.5. Furthermore, the TAC showed yellow index of 1.7, haze of 0.08, and transparency of 93.5%. This TAC was composed of the cellulose from cotton.

### Preparation of Dope

The dope 21 was prepared by a dope production apparatus (not shown). The above solvents were mixed well in a 4000-litter stainless stock tank having a stirring blade, and a mixed solvent was obtained. The moisture content in each solvent material was not greater than 0.5 wt. %. Then, flakes of TAC were added gradually from a hopper to the mixed solvent. In particular, the TAC flakes were poured into the stock tank, and dispersed for 30 minutes by two stirrers, a dissolver type eccentric stirrer rotating at 5 m/sec, and an anchor blade stirrer having an anchor blade at the central shaft rotating at 1 m/sec. The temperature was 25° C. at the start of the dispersion, and increased to 48° C. A previously prepared additive solution was added from an additive tank until the mixed solvent weighed 2000 kg. When the additive solution was dispersed completely, the stirrers were stopped once. The mixed solvent was then stirred again for 100 minutes with the stirrer that rotated at 0.5 m/sec, so that the TAC flakes swelled to change the mixed solvent into a swelling liquid. Inside of the tank was pressurized to 0.12 MPa by nitrogen gas until the TAC flakes finished swelling. During this time, the oxygen level in the tank was maintained below 2 vol. % to prevent explosion. The moisture content of the swelling liquid was 0.3 wt. %.

This swelling liquid was sent to a pipe equipped with a jacket. The jacket heated the swelling liquid to 50° C. firstly, then heated to 90° C. under pressure of 2 Mpa, and the swelling liquid was melt completely. The heating operation lasted for 15 minutes. The melt liquid was cooled to 36° C. using a temperature controller, and introduced through a filtering device having a filter with nominal pore diameter of 8 μm. The dope (hereinafter, pre-concentration dope) was therefore obtained. The filtering device was set to have the primary pressure level of 1.5 MPa and the secondary pressure level of 1.2 MPa. Having to withstand high temperatures, such components of the filtering device as the filter, the housing, and the pipes were made of hastelloy (trademark), the highly corrosion resistant metal alloy. Additionally, the filtering device was equipped with a jacket in which a heat transfer medium flows to keep the device warm.

The pre-concentration dope made in this way was evaporated under normal pressure at 80° C. in a flash evaporator, and the solvent vapor was collected by a condenser. In the dope 21 made by this flash evaporation, the density of the solid content became 21.8 wt. %. On the other hand, the condensed solvent was collected by a recovery device for later reuse as the dope solvent. The collected solvent vapor was restored by a restoring device, and sent to the stock tank 11. Along the way through the condenser and the recovery device, the solvent was distilled and dehydrated. Provided in the flash tank of the flash evaporator was an anchor blade stirrer (not shown) having an anchor blade at the central shaft, which was rotated at 0.5 m/sec to stir and defoam the flashed dope. The temperature of the dope was 25° C. in the flash tank, and the average dope retention time in the flash tank was 50 minutes. The shear viscosity of this dope was 450 Pa·s at 25° C. with the shear velocity at 10(Sec⁻³).

Consequently, the dope 21 was exposed to weak ultrasound to remove bubbles. The dope 21 was then sent to 1.5 Mpa to a filtering device by a pump that increased the air pressure. In the filtering device, the dope 21 passed through a sintered metal fiber filter with nominal pore diameter of 10 μm and a sintered fiber filter with nominal pore diameter of 10 μm consecutively. The primary air pressure for these filters was 15 MPa and 1.2 Mpa respectively, and the secondary air pressure for the two was 1.0 Mpa and 0.8 MPa respectively. The dope after the filtration was heated to 36° C. and put in a 2000-litter stainless stock tank 11. In the stock tank 11, the dope 21 was stirred constantly by the stirring blade 11b rotating at 0.3 m/sec. For that matter, no corrosion can be found at places that the dope contacted during the dope preparation from the pre-concentration dope.

Using the film manufacturing apparatus 10, the film 20 was manufactured from the dope 21. The dope 21 was supplied by the gear pump 25 having an inverter motor that was controlled to increase the air pressure on the primary side to 0.8 MPa. The gear pump 25 operated at 99.2% volumetric efficiency, and 0.5% or less flow rate variation. The outflow pressure was 1.5 MPa. Under the control of a controller (not shown), the gear pump 25 sent the dope 21 from the stock tank 21 to the die 30 through the filtering device 26 where the dope 21 was filtered.

During the casting process, the casting dope 30 and its pipes were kept at substantially 36° C. by a temperature controller on the die 30. The die 30 was a coat hanger die equipped with thickness adjustment bolts (heat bolts) aligned at 20 mm intervals for an automatic thickness adjustment function. These heat bolts were able to work on the profile set according to the flow rate of the gear pump 25, and allow feed back control under the adjustment program set based on the profile of an infrared thickness gauge (not shown) in the film manufacturing apparatus 10. The die 30 was controlled to achieve 1 μm or less thickness difference between two points 50 mm apart on the film whose side edges had been removed by 20 mm, and to achieve 3 μm/m or less thickness variation across the film width. The total thickness of the film was controlled to ±1.5% or below.

The die 30 was made of precipitation hardening stainless steel with the coefficient of thermal expansion of 2×10⁻⁵ (° C.⁻¹) or less. This die 30 showed substantially the same resistance to corrosion in an electrolyte solution as the SUS316 casting die in the corrosion test. Because of this resistance to corrosion, the die 30 withstood for 3 months in a mixed liquid of dichloromethane, ethanol, and water without pitting at air-liquid interface. The die 30 was precisely finished to a surface roughness of 1 μm or less and a straightness of 1 μm/m or less in all directions, and the slit clearance was adjusted to 1.55 mm. Across the width of the slit, the lip tip was rounded into or below 50 μm radius on the solution flowing side. The shear velocity of the dope 21 inside the die 30 was in the range of 1(1/sec) to 5000(1/sec). The lip tip of the die 30 was coated with a hardened layer of tungsten carbide (WC) formed by a spraying technique.

The support was the casting drum 32 of columnar shape. The drum 32 had a chrome plated, mirror finish peripheral surface 32a, whose surface roughness was not greater than 0.05 μm. Made of SUS316, the drum 32 had sufficient resistance to corrosion and sufficient strength. Under the control of a controller (not shown), the drum 32 was rotated around a shaft 32b. The casting speed, or in other words the moving speed of the peripheral surface 32b was approximately 80 m/min. The variation in speed of the drum 32 was controlled to 0.5% or less. Additionally, the positions of the both edges of the drum 32 were kept detected to control the threading of the cast drum 32 to 1.5 mm or less in one rotation. The distance variation between the tip of the die lip and the drum 32 was adjusted to or below 200 μm. The casting drum was placed in the casting chamber equipped with a pressure variation suppressing device (not shown).

Provided inside the drum 32 was a passage for a heat transfer medium that changes a temperature T1 of the peripheral surface 32a. This heat transfer medium was supplied by the heat transfer medium circulator 37. Immediately before the casting of the dope, the temperature of the peripheral surface 32a was 0° C. at its center part, and the temperature difference between the side edges of the peripheral surface 32a was not greater than 6° C. The drum 32 should have few or no surface defects, and in the present embodiment the drum 32 had no pinholes of above 30 μm, 1/m² or less pinholes of 10-30 μm, and 2/m² or less pinholes of below 10 μm.

The concentration of oxygen was kept to 5 vol. %% on the drum 32 under a dry condition. In order to keep the enzyme concentration to 5 vol. %, the air was substituted with nitrogen gas. Additionally, the condenser 39 was provided to condense and collect the solvent in the casting chamber 12, and the outlet temperature of the condenser 39 was set at 3° C. Static pressure variation near the die 30 was regulated to or below ±1 Pa.

On the primary side (the upstream side in the moving direction of the peripheral surface 32a) of the die 30, the decompression chamber 36 was placed to reduce the air pressure on the primary side (back side) of the bead 21a. According to the speed of the peripheral surface 32a, the decompression chamber 36 was controlled to generate a 1-5000 Pa pressure difference between the front and back sides of the bead 21a. For that matter, the pressure difference was further controlled such that the bead 21a became 20-50 mm in length. The decompression chamber 36 also had a jacket (not shown) to keep a constant temperature inside the decompression chamber 36. Supplied inside the jacket was the heat transfer medium at 35° C. Additionally, the decompression chamber 36 was able to increase the temperature higher than the condensation temperature of the gas around the cast area. Additionally, labyrinth seals (not shown) were provided at the front and the rear sides of the bead 21a.

A mixed solvent A composed of 50 wt. % of dichloromethane and 50 wt. % of n-butanol was prepared as the solidification preventive solution, and put in a tank 62 of the solution supply device 60, where the solution was kept at the temperature of 20-30° C.

Placed at both side end portions of the die 30 were the nozzles 61a, 61b that supply the solidification preventive solution. Each of these nozzles 61a, 61b was arranged with the clearance CL1 of 2 mm between the supply port 61c and the position 90, and with the clearance CL2 of 2 mm between the extension of the center line of the supply port 61c and the side end 21b of the bead 21a.

In the film manufacturing apparatus 10, the dope 21 was cast into 80 μm dry thickness from the die 30 onto the peripheral surface 32a, and the casting film 33 was formed. Along the way, the dope 21 formed the bead 21a between the discharge slit 30a and the peripheral surface 32a. On the back side of the bead 21a, the air pressure was reduced to a certain value by the decompression chamber 36. The solution supply device 60 delivered the solidification preventive solution to the both side end areas of the bead 21a.

In the casting chamber 12, the evaporated solvents were changed into liquid by the condenser 39 at −3° C., and collected by the recovery device 40. The collected solvents were adjusted to or below 0.5% water volume. On the other hand, the dry air separated from the solvents was heated again and reused as the dry air. The casting film that had developed the self supporting property was peeled from the drum 32 by the peel roller 34, and became the wet film 38. The peeling speed (peel roller draw) was adjusted to the range of 100.1-110% with respect to the speed of the drum 32, so that the casting film 33 could be peeled off completely. Consequently, the wet film 38 was transferred to the pin tenter 13 by a pass roller 63, which had an air blower to breeze dry air at 60° C. toward the wet film 38. The pin tenter 13 and the clip tenter 14 dried the wet film 38 to reduce the remaining solvents to a certain amount (5 wt. % or less), and thus the film 20 was obtained. In this example, the films were manufactured under four different air pressure levels (−100 Pa, −150 Pa, −200 Pa, and −300 Pa with respect to the front side of the bead 21a), and the solidification preventive solution was not blown to the bead 21a with each air pressure level, causing no surface defect to the film 20.

### Comparative Example 1

The solution casting method was conducted under the same condition as the above working example, except that the nozzles 61a, 61b were arranged with the clearance CL1 of approximately 0 mm. With each air pressure level, the solidification preventive solution was blown to the dope 21 and caused the surface defect to the film 20.

### Comparative Example 2

The solution casting method was conducted under the same condition as the above working example, except that the nozzles 61a, 61b were arranged with the clearance CL2 of approximately 0 mm. With each air pressure level, the solidification preventive solution was blown to the dope 21 and caused the surface defect to the film 20.

### Comparative Example 3

The solution casting method was conducted under the same condition as the above working example, except that the nozzles 61a, 61b were arranged on the side edges of the die 30, so that each supply port 61c could face one side edge of the bead 21. The films were manufactured under the different air pressure levels of −100 Pa, −120 Pa, and −150 Pa with respect to the front side of the bead 21a, and with each air pressure level, the solidification preventive solution was blown to the dope 21 and caused the surf ace defect to the film 20. Especially, the surface defect became worst under the air pressure level of −150 Pa.

The results of the working example and the comparative example 3 show that supplying the solidification preventive solution from the front side of the bead 21a serves to prevent the solution from being blown to the decompression chamber 36 by the airflow derived from the air reduction. Additionally, the results of the working example and the comparative examples 1 and 2 show that the solidification preventive solution is not caught in the airflow nor blown to the decompression chamber 36 when the nozzles 61a,61b are arranged with the CL1 and CL2 within a certain range. If the solution casting is conducted at low speed (with the support moving at below 80 m/min), the air pressure is not reduced greatly and thus the preventive solution supplied from the front side of the bead 21a will not be blown by the airflow. However, at high speed (with the support moving at or above 80 m/min), the air pressure has to be reduced greatly and the blowing of the solution becomes a problem. This problem is more serious when the air pressure is reduced by 300 Pa or more, and it is at this point that the effect of the present invention becomes prominent. According to the present invention, the blowing of the solution, i.e., the cause of the film surface defect is prevented, and the films are manufactured efficiently.

### INDUSTRIAL APPLICABILITY

The present invention is suitable for the manufacture of photographic films, polarizing filter protection films and optical compensation films.

1. A solution casting method for polymer films comprising:
a casting step to cast a dope including a polymer and a solvent from a casting die onto a moving support, said dope forming a bead between said casting die and said support;
a decompression step to reduce air pressure on an upstream side of said bead in a moving direction of said support; and
a solution supply step to supply a solidification preventive solution from a wall surface of said casting die to both side end portions of a downstream surface of said bead in said moving direction, said solidification preventive solution preventing solidification of said dope.

2. The solution casting method of claim 1, wherein said support moves at or above 80 m/min, and said air pressure on said upstream side of said bead is reduced by 100 Pa or more with respect to a downstream side of said bead.

3. The solution casting method of claim 1, wherein said support is a peripheral surface of said casting drum.

4. The solution casting method of claim 1, wherein said solvent and said solidification preventive solution include a good solvent for said polymer as their main components.

5. The solution casting method of claim 1, wherein said polymer contains cellulose acylate or cyclic polyolefin.

6. The solution casting method of claim 4, wherein said good solvent is dichloromethane or methyl acetate.

7. A solution casting apparatus for polymer films comprising:
a moving support;
a casting die for casting a dope including a polymer and a solvent onto said support, said dope forming a bead between said casting die and said support;
a decompression chamber for reducing air pressure on an upstream side of said bead in a moving direction of said support; and
a solution supplying device for supplying a solidification preventive solution from a wall surface of said casting die to both side end portions of a downstream surface of said bead in said moving direction, said solidification preventive solution preventing solidification of said dope.

8. The solution casting apparatus of claim 7, wherein said support moves at or above 80 m/min, and said decompression chamber reduces said air pressure on said upstream side of said bead by 100 Pa or more with respect to a downstream side of said bead.

9. The solution casting apparatus of claim 7, wherein said support is a peripheral surface of a casting drum.

10. The solution casting apparatus of claim 7, wherein said solvent and said solidification preventive solution include a good solvent for said polymer as their main components.

11. The solution casting apparatus of claim 7, wherein said polymer contains cellulose acylate or cyclic polyolefin.

12. The solution casting apparatus of claim 10, wherein said good solvent is dichloromethane or methyl acetate.

13. The solution casting apparatus of claim 7, wherein said solution supplying device includes a pair of nozzles whose openings are located at both side end portions of said wall surface of said casting die.

14. The solution casting apparatus of claim 13, wherein each of said openings is arranged with a clearance CL1 between a tip of said nozzle and said bead, and with a clearance CL2 between an extension of a center line of said nozzle and a side edge of said bead, said clearances CL1 and CL2 being in the rage of 1 mm to 5 mm.
